(19) United States
(12) Patent Application Publication
(10) Pub. No.: US 2025/0321775 A1
(43) Pub. Date: Oct. 16, 2025

(54) Dynamic Distribution of High Available (HA) Virtual Network Functions

(71) Applicant: Harmonic, Inc., San Jose, CA (US)

(72) Inventors: Adam Levy, Hadera (IL); Alex Muller, Pardes Hanna-Karkur (IL); Andrii Schevchenko, Kyiv (UA); Taras Lemkin, Kyiv (UA); Oleksandr Zolotarov, Kyiv (UA); Ayman Jabarin, Hadera (IL)

(73) Assignee: Harmonic, Inc., San Jose, CA (US)

(21) Appl. No.: 19/059,082

(22) Filed: Feb. 20, 2025

Related U.S. Application Data
(60) Provisional application No. 63/556,360, filed on Feb. 21, 2024.

(51) Int. Cl. G06F 9/455

(52) U.S. Cl. CPC G06F 9/45558; G06F 2009/45595

(57) ABSTRACT

Dynamic, seamless management of virtual network function (VNF) in a highly available (HA) environment. An instance management program instantiates software instances in which a plurality of VNFs reside. A type of VNF is a MAC Domain (MD) VNF, which is a virtual network function that implements the DOCSIS CMTS MAC layer for a particular MAC domain. Upon determining that a particular VNF executing within a first software instance managed by an instance management program should be moved to a second software instance, the particular VNF is moved from the first software instance to the second software instance without ceasing operation of any other VNF also executing in the first software instance. A software instance may have both active and standby VNFs comprised therein. Failover operations of a particular VNF may be performed during runtime without ceasing operation of any of software instance or VNF not associated with the failed VNF.

### CLAIM OF PRIORITY

The present application claims priority to U.S. Provisional Patent Application No. 63/556,360, filed on Feb. 21, 2024, entitled ‘Dynamic Load Balancing of Virtual Access Instances Across Packet Processing Pods Using High Availability,’ the entire contents of which are incorporated by reference for all purposes as if fully set forth herein.

### FIELD OF THE INVENTION

Embodiments of the invention generally relate to managing the operation and deployment location of virtual network functions in a high availability (HA) environment.

### BACKGROUND

A Cable Modem Termination System (CMTS) is a component responsible for providing services, such as cable television, Internet, or Voice over Internet Protocol (IP), to subscribers. A CMTS is typically embodied as a physical piece of special-purpose hardware equipment, although software implementations of a CMTS, executable on general purpose computer equipment, are known in the art, such as the cOS™ Broadband Platform family of products available from Harmonic, Inc. of San Jose, California.

The manner in which a cable service provider may use a CMTS to provide services to cable subscribers is governed, at least in part, by Data Over Cable Service Interface Specifications (DOCSIS), which is a collection of industry-recognized standards for transferring data over a cable system network. In providing service to subscribers, a CMTS sends data to customer premises equipment (CPE) of the subscriber over downstream channels (which operate in the direction of the CMTS to the customer premises equipment (CPE) of the subscriber) and receives data from the subscriber over upstream channels (which operate in the direction of the customer premises equipment (CPE) to the CMTS).

A MAC Domain (MD) is a logical association that is used by certain entities, such as a CMTS, when providing DOCSIS functions for a set of upstream and downstream channels. A MD comprises some number of downstream (DS) channels and some number of upstream (US) channels. A typical MD may have many downstream channels, such as 32 for example. A MD also typically specifies at least one downstream (DS) port of the CMTS and at least one upstream (US) port of the CMTS.

A practical requirement of certain systems, such as a cable network, is to ensure that the service is always operational so that subscribers can receive service whenever they wish. This expectation is known in the art as High Availability (HA), which essentially means that for a system to be considered HA, the system must be capable of operating continuously by eliminating single points of failure and achieving certain agreed-upon performance metrics.

Cable service providers in the current state of the art rely upon redundancy to ensure that functions pertaining to a MD are HA. One mechanism used in the prior art to provide redundancy is ensure that there is no single point of failure in the system such that any software instance that performs services for a MD has a redundant instance which may assume the responsibilities of a software instance that becomes inoperable for any reason.

To illustrate how redundant software instances might be used in the present state of the art, an example will be presented below that references FIG. 1, which is an illustration of a high availability (HA) system 100 that services eight different MDs. FIG. 1 depicts software instances 10, 12, 14. Software instances 10, 12, 14 may be implemented by a Kubernetes pod. Software instances 10 and 12 are currently designated as being active software instances and software instance 14 is currently designated as being a standby software instance.

Each of software instances 10, 12, and 14 each comprise a number of software units that each support a virtual network function (VNF). A VNF is a commonly used, well-understood term in the art used to refer to virtualized network services which often now execute on open computing platforms, whereas in the past they were carried out by proprietary, dedicated hardware technology. Common VNFs include virtualized routers, firewalls, WAN optimization, and network address translation (NAT) services.

An MD VNF is a virtual network function that implements the DOCSIS CMTS MAC layer for a particular MAC domain. In the example shown in FIG. 1, the MAC domain supported by each MD VNF in each software instance is identified by a number. For example, active software instance 10 comprises four active MD VNFs, denoted 1-4, which respectively support one of MD 1-4. Similarly, active software instance 12 comprises four different active MD VNFs, denoted 5-8, which respectively support one of MD 5-8. Standby software instance 14 comprises 8 different MD VNFs, denoted 1-8; the MD VNF in standby software instances serve as redundant MD VNFs to assume responsibility if a corresponding MD VNF becomes inoperable. As shown in FIG. 1, each of the eight different MAC domains supported by system 100 has a corresponding MD VNF in one active software instance and at least one standby software instance. For example, there is a MD VNF for MAC domain access instance 4 in active software instance 10 and standby software instance 14.

To ensure HA in system 100, if an operational problem disrupts the proper execution of any active software instance, then a standby software instance assumes responsibility for serving the MAC domains previously serviced by the failed software instance. For example, if software instance 10 were to become inoperable, then MD VNF 1-4 executing in software instance 10 would also become inoperable. To ensure HA, standby software instances 1-4 executing in software instance 14 take over as being active software instances to service MAC domains 1-4. Meanwhile, active software instances 5-8 executing in software instance 12 would continue to be active and service MAC domains 5-8.

The approach of FIG. 1 is a simplified example that only includes a small number of software instances and MAC domains to illustrate the principles of the prior art. However, in a real implementation, there will likely be a large number of software instances that are each delegated a large portion of computational resources. Consequently, it is desirable to provide a high availability (HA) environment for services that involve MAC domains, including but not limited to cable television, Internet, or Voice over IP, in a manner that provides benefits over the current state of the art.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is an illustration of a high availability (HA) system that comprises eight units of software instances that services eight different MAC Domains (MDs) in accordance with the prior art;

FIG. 2 is a block diagram of a Cable Modem Termination System (CMTS) in which an embodiment of the invention may be deployed;

FIG. 3 is a block diagram of a Passive Optical Network (PON) in which an embodiment of the invention may be deployed;

FIG. 4A is a flowchart illustrating the high-level steps for performing dynamic, seamless management of MD VNFs involving an initialization operation in a highly available (HA) environment in accordance with an embodiment of the invention;

FIG. 4B is a flowchart illustrating the high-level steps for performing dynamic, seamless management of MD VNFs involving a failover operation in a highly available (HA) environment in accordance with an embodiment of the invention;

FIG. 4C is a flowchart illustrating the high-level steps for performing dynamic, seamless management of MD VNFs involving a move operation in a highly available (HA) environment in accordance with an embodiment of the invention;

FIG. 5 is an illustration of active and standby MAC Domain (MD) Virtual Network Functions (VNFs) in a highly available (HA) environment in accordance with an embodiment of the invention;

FIG. 6 is an illustration of the increased scale capacity which may be realized using an embodiment of the invention;

FIG. 7 is an illustration of the savings in computational resources which may be realized by managing MD VNFs in a highly available (HA) environment in accordance with an embodiment of the invention;

FIG. 8 is an illustration of the increased resources which may optionally be made available to active MD VNFs in a highly available (HA) environment in accordance with an embodiment of the invention;

FIG. 9 is an illustration of the increased utilization of computational resources which may be realized by managing MD VNFs in a highly available (HA) environment in accordance with an embodiment of the invention;

FIG. 10 is an illustration of an aggregate view showing optimization techniques discussed herein for resources, throughput, and scale in accordance with certain embodiment of the invention;

FIGS. 11A and 11B are two halves of an illustration of performing dynamic load balancing of MD VNFs using an embodiment of the invention; and

FIG. 12 is a block diagram of a computer system that may correspond to, in whole or in part, a Cable Modem Termination System (CMTS) or an Optical Line Terminal (OLT) in accordance with an embodiment of the invention.

### DETAILED DESCRIPTION OF THE INVENTION

Approaches for dynamic, seamless management of Virtual Network Functions (VNFs) in a high availability (HA) environment are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

Embodiments discussed herein involving HA environments that comprise standby instances, acting as backups for active instances, which must be fully and constantly synchronized to the state of the active instances so that a particular backup instance may take over for the active instance its failure, with minimal service impact.

A Virtual Network Function, or as abbreviated herein VNF, is a commonly used, well-understood term in the art used to refer to a virtualized network service. A VNF may execute on open computing platforms, whereas in the past they were carried out by proprietary, dedicated hardware technology. Common VNFs include virtualized routers, firewalls, WAN optimization, and network address translation (NAT) services. A MAC Domain (MD) VNF is a virtual network function that implements the DOCSIS CMTS MAC layer dataplane for a particular MAC domain. While examples and embodiments of the invention may be explained herein with reference to a MD VNF, embodiments of the invention may be employed to manage the operation of any type of VNF and are not limited to the use of MD VNF.

### Functional Overview

Embodiments of the invention advantageously enable the dynamic, seamless management of Virtual Network Functions (VNFs) in a high available (HA) environment. The approaches discussed herein allow for a finer granularity of management than the prior art, as individual MD VNFs may be migrated from one software instance to another during runtime without disrupting the operation of other MD VNFs at either the origin software instance or the destination software instance.

Advantageously, embodiments allow for MD VNFs to be load-balanced in a seamless fashion between software instances or other deployment locations. Certain embodiments of the invention require fewer computational resources to support MD VNFs in a HA, which can result in a substantial savings in computational resources, and by extension, financial cost to the system operator. Approaches shall be discussed which allow VNFs, such as but not limited to MD VNFs, to be migrated to other locations for a variety of reasons, including load-balancing, ensuring a quality of service (QOS) for a particular subscriber, dynamically adjusting to an increase or decrease in available computational resources, and/or adjusting to an increase or decrease in subscriber demand. These and other features shall be discussed in greater detail below; however, before doing so, it will be helpful to review certain technical contexts in which embodiments may be deployed.

### System Overview

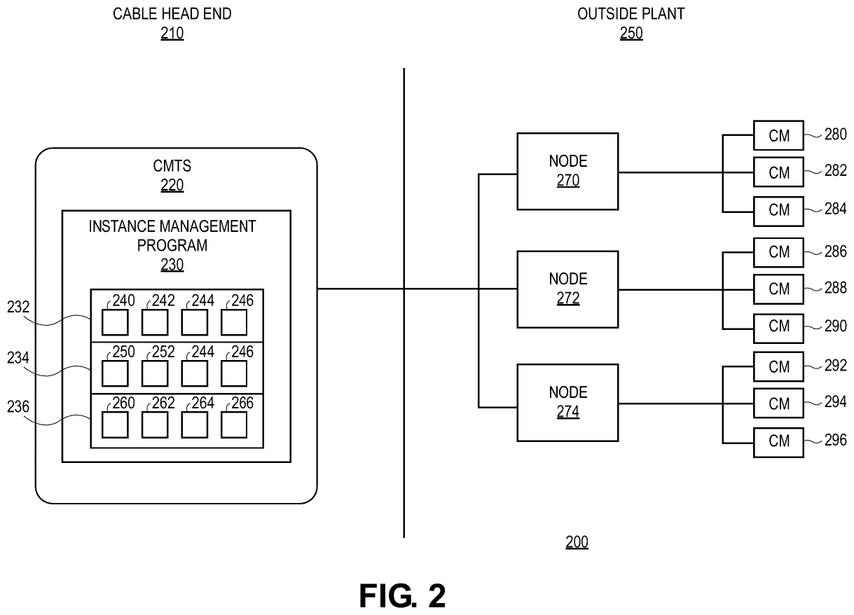

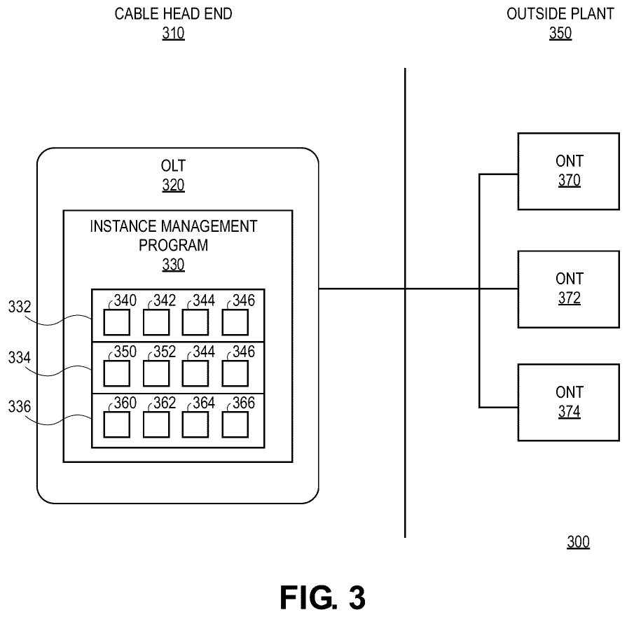

Embodiments of the invention may be implemented in a number of different technical contexts. To illustrate a couple concrete examples, particular embodiments will be discussed relative to FIGS. 2 and 3, but other deployment contexts are possible without deviating from the spirit and scope of the teachings herein, as embodiments may be used in any technical context in which a plurality of MAC domain access instances are deployed in a HA.

FIG. 2 is a block diagram of system 200 comprising a Cable Modem Termination System (CMTS) 220 in which an embodiment of the invention may be deployed. CMTS 220 will typically reside at a central location under control of the operator of system 200, such as a cable head end 210. CMTS 220 includes, makes use of, or co-operates with instance management program 230, which, as broadly used herein, represents any type of software application for managing the deployment and operation of units of computer resources. Non-limiting, illustrative examples of instance management program 230 include the open-source system Kubernetes (K8), Amazon Web Services by Amazon, Inc., Docker Engine by Docker Inc., OpenShift by Red Hat, Inc., and Google Cloud Platform by Google, Inc.

Each instance management program may use different terms, such as container or pod, to refer to the units of computer resources managed thereby. As broadly used herein, the term ‘software instance’ shall be used to the group of computer resources, organized as a unit and managed by an instance management program, regardless of which particular term the instance management program uses to refer to the concept; for example, as used herein, the term ‘software instance is meant to include reference to a Kubernetes pod and the like. FIG. 2 depicts three software instances, namely software instances 232, 234, and 236.

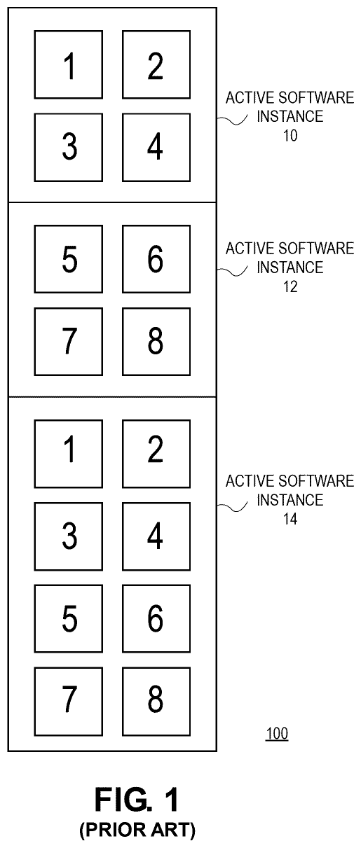

A software instance, such as software instances 232, 234, and 236, may comprise a software process or a set of related processes executed by hardware. For example, one or more VNFs, such as but not limited to a MD VNF, may be located within a software instance. Recall that a MD VNF, as broadly used herein, may refer to a software application that performs functions for a particular MAC domain (MD). In the example of FIG. 2, a MD VNF may be embodied as a logical unit of software that performs DOCSIS functions for a set of channels extending at least between the CMTS and a plurality of Cable Modems (CMs). As shown in FIG. 2, MD VNFs 240, 242, 244, and 246 execute in software instance 232, MD VNFs 250, 252, 254, and 256 execute in software instance 234, and MD VNFs 260, 262, 264, and 266 execute in software instance 236. Unlike the software instances shown in FIG. 1, software instances in system 200 may, but need not, comprise any software instances comprising only standby MD VNFs, as shall be explained in greater detail below.

CMTS 220 provides service to cable subscribers by sending and receiving data over the network, extending outside plant 250, to cable nodes, to a cable modem (CM) associated with the customer. As the architecture of a cable network can be arbitrarily complex, FIG. 2 depicts a simplified version depicting a few, but salient, elements of a cable network. Nodes 270, 272, and 274 may be embodied by a Ripple Modular DAA Node available from Harmonic, Inc of San Jose, California. As is well known to those in the art, a cable network may comprise any number of nodes and any number of CMs, and certainly more than CMs 280-296 shown in FIG. 2. Customer premise equipment (abbreviated CPE, not depicted in FIG. 2) may communicate with a particular CM associated with the cable subscriber to receive service from CMTS 220.

FIG. 3 is an example of a different context in which embodiments of the invention may be deployed. FIG. 3 is a block diagram of a Passive Optical Network (PON) 300 in which an embodiment of the invention may be deployed. PON 300 provides service to customers by sending and receiving data over a fiber-optic network that connect an Optical Line Terminal (OLT) 320 that comprises instance management program 330. Instance management program 330 of FIG. 3 manages software instances 332, 334, and 336, in each of which executes a portion of VNFs 340-366 as shown in FIG. 3. In the example of FIG. 3, a VNF may be embodied as a logical unit of software that performs Broadband Network Gateway (BNG) functions for a set of channels extending at least between OLT 320 and a plurality of Optical Network Terminals (ONTs) 370, 372, and 374. As understood to those in the art, a practical deployment of a PON will be more complex than that depicted FIG. 3, by those in the art may appreciate how to make and use embodiments of the invention by building an instance management program 330 in a PON using the teachings presented herein.

### Dynamic, Seamless Management of Virtual Network Functions

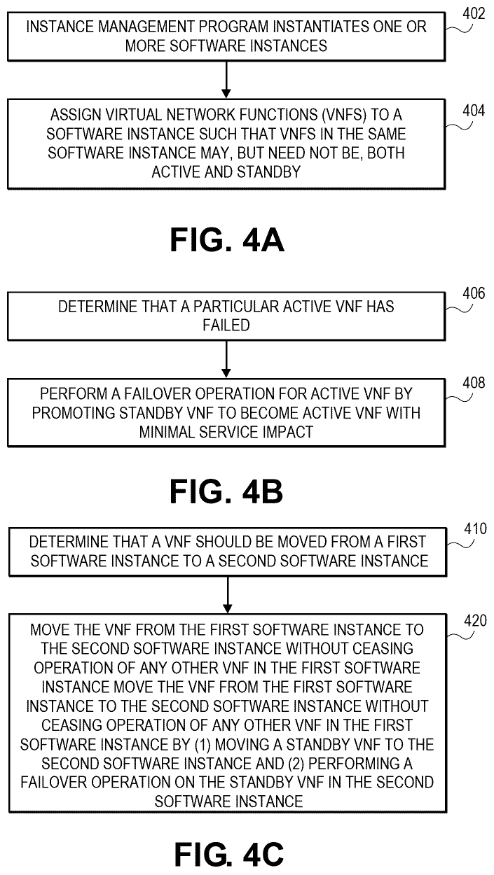

FIG. 4A is a flowchart illustrating the high-level steps for performing dynamic, seamless management of MD VNFs involving an initialization operation in a highly available (HA) environment in accordance with an embodiment of the invention. Initially, in step 402, an instance management program instantiates one or more software instances. For example, in performing step 410, instance management program 230 may instantiate software instance 232 of FIG. 2. Each software instance instantiated in step 410 may execute upon hardware, such as computer system 1200 described below. For purposes of providing a concrete example, the steps of FIG. 4A will be explained herein with reference to an example of software instance 232 comprising MD VNFs 240, 242, 244, and 246 being instantiated in step 410.

In step 420, instance management program 230 may assign certain MD VNFs to a particular software instance. In doing so, instance management program 230 may assign a MD VNF to a particular software instance based, at least in part, on whether that MD VNF is an active MD VNF or a standby MD VNF. An active MD VNF is a VNF that is presently operating and executing a set of functions for a particular MAC domain; whereas, a standby MD VNF serves as a backup MD VNF for a particular active MAC domain, which may assume the work responsibilities of an active MD VNF in case the active MD VNF encounters an issue that renders it partially or wholly inoperable. Only the active MD VNF actively receives data packets associated with a particular MAC domain. A standby MD VNF does not receive packets to be processed while designed as a standby MD VNF, but is nevertheless is configured to assume the responsibilities of the networking and the dataplane and control plane associated with a particular MAC domain.

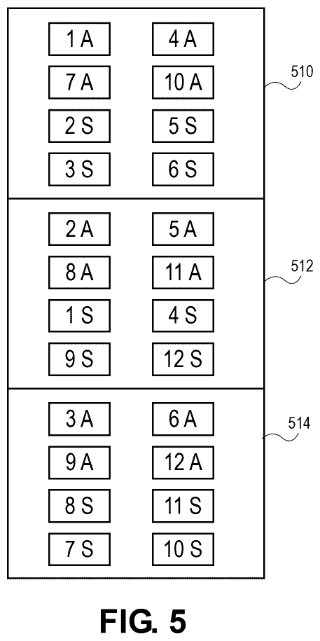

MD VNFs 240, 242, 244, and 246 may be all active, all standby, or importantly, a mixture of both active and standby MD VNFs. Thus, unlike the prior art, the MD VNFs in an executing software instance need not all be active or all standby. For example, consider FIG. 5, which depicts an example involving software instances 510, 512, and 514, each of which comprises both active and standby MD VNFs.

New VNFs according to embodiments of the invention are created differently than in the prior art. Previously, a Kubernetes pod may be assigned an IP address, and any VNFs residing in that Kubernetes pod use that assigned IP address associated with that Kubernetes pod of the prior art. In contrast, according to embodiments of the invention, when either a new active MD VNF or a new standby MD VNF is created, that MD VNF is configured to possess one or more IP addresses associated with the MAC domain to which it services. In an embodiment, the CMTS may configure the newly created MD VNF with the appropriate IP address. The CMTS may maintain a number of different IP addresses for each MAC domain, whereby each of the IP addresses is to be used with a different network protocol or other such criterion. The CMTS may thus assign a particular IP address to a particular newly created MD VNF based on what is appropriate for the work that the MD VNF is performing for a particular MAC domain.

FIG. 4B is a flowchart illustrating the high-level steps for performing dynamic, seamless management of MD VNFs involving a failover operation in a highly available (HA) environment in accordance with an embodiment of the invention. A failover operation refers to an operation to recover an active VNF that has ceased to function. When an active VNF ceases to operate, a failover operation is performed so that a corresponding standby VNF may assume the responsibilities of the failed VNF, and become the newly designated active VNF.

A MAC domain may be serviced by one active MD VNF and one or more standby MD VNFs. A standby MD VNF associated with a particular MD domain generally resides in a different software instance than the corresponding active MD VNF for that MAC domain. To illustrate, consider FIG. 5, which is an illustration of active and standby MD VNFs in a highly available (HA) environment in accordance with an embodiment of the invention. FIG. 5 depicts three software instances, namely software instances 510, 512, and 514. Each of software instances 510, 512, and 514 comprises eight MD VNFs that perform work functions for one of eight MAC domains. In FIG. 5, the MAC domain for which each eight MD VNFs is identified with a number 1-8. Also in FIG. 5, as well as in other drawings, the letter A or the letter S has been appended to the numerical label of a VNF in certain instances to signify whether that MD VNF is active or standby respectively. Thus, as shown in FIG. 5, each software instance comprises both active and standby MD VNFs, e.g., software instance 514 comprises the four active MD VNFs 3A, 6A, 9A, and 12A and the four standby MD VNFs 8S, 11S, 7S, and 10S. Further, the corresponding standby MD VNFs for the active MD VNFs in a single software instance may, but need not, be disposed across different software instances, e.g., the active MD VNF 3A executes in software instance 514 while the corresponding standby MD VNF 3S resides in software instance 510, and the active MAC MD VNF 1A executes in software instance 510 while the corresponding standby MD VNF 1S resides in software instance 512.

To explain a concrete example of a failover operation, assume in step 406 that the MD VNF actively servicing MAC domain 6, or MD VNF 8A, encounters an operational problem that renders it unable to continue operation. The operational problem may be detected by instance management program or by a Cable Modem Termination System (CMTS), depending upon implementation. Alternately, a failover operation may be initiated manually by a user or by an automated process in response to a one or more conditions being satisfied. Next, in step 408, MD VNF 6S residing in software instance 510 would become active, and contemporaneously, a new standby MD VNF would be created, typically in a software instance other than software instance 510.

FIG. 4C is a flowchart illustrating the high-level steps for performing dynamic, seamless management of VNFs, such as but not limited to MD VNFs, involving a move operation in a highly available (HA) environment in accordance with an embodiment of the invention. The steps of FIG. 4C will be explained with reference to concrete examples involving instance management program 230 of FIG. 2, but those in the art may appreciate, without an undue burden, that these teachings of FIGS. 4A-4C may be applied to instance management programs in other technical contexts, such as instance management program 330 in a PON environment.

In the performance of step 410, a determination is made that a particular VNF should be moved from a first software instance to a second software instance. Different embodiments allow for different entities to make this determination. According to one embodiment of the invention, an instance management program may be the entity that makes that determination. For example, instance management program 230 may determine that MD VNF 240 should be moved from software instance 232 to software instance 234. In other embodiments of the invention, another software entity, besides an instance management program, may make that determination in step 410 that a particular VNF should be moved from a first software instance to a second software instance. For example, in an embodiment, a software-implemented Cable Modem Termination System (CMTS) or a standalone executable software unit different than both a CMTS and an instance management program (termed a VNF orchestrator) may render the determination that a particular VNF should be moved from a first software instance to a second software instance.

The determination that a particular VNF should be moved from a first software instance to a second software instance may be made for a variety of reasons, such as to perform load-balancing, recover a failed VNF, optimize for either resources, electrical power consumption, throughput, or scale, ensure that certain subscribers receive a certain quality of service, and right size in response to a change in demand, be it either an increase or a decrease in demand. Such considerations will be discussed in greater detail below.

In step 420, the VNF may move from the first software instance to the second software instance without ceasing operation of any other of VNF in the first software instance. If another entity besides an instance management program determined in step 410 that the VNF should be moved first software instance to the second software instance, then that entity may instruct or otherwise work with the instance management program to perform certain tasks required to move the VNF to the second software instance.

Embodiments of the invention allow for any active MD VNF to be moved from an existing software instance (the “source software instance”) to a different software instance (the “destination software instance”) by the instance management program. To do so, first, if a standby MD VNF corresponding to the active MD VNF does not yet exist in the destination software instance, that standby MD VNF for the active MD VNF to be moved is moved from its present location to the destination software instance. A standby MD VNF corresponds to an active MD VNF if both the standby and the active MD VNF are configured to perform work for the same MAC domain. Next, the standby MD VNF in the destination software instance becomes the new active MD VNF for that MAC domain as a result of performing a failover operation, and a new standby MD VNF is created for the MAC domain.

When a standby MD VNF becomes active, that standby MD VNF notifies the network that it now owns the IP addresses for that MAC domain, e.g., that standby VNF may use a standard network protocol to notify a switch in the network that this IP address is now owned by a MAC address on a certain port of a switch, which is associated with the location of the newly promoted active MD VNF, The instance management program may then delete the failed active VNF and a new standby VNF is created, either in the original source software instance or in a different software instance.

The ability to move or failover any active MD VNF separately from other MD VNF in runtime allows savings in both computational resources, and by extension, power expenditures and financial cost to the operator, as shall be explained in greater detail below. Embodiments allow a MD VNF to be decoupled from the software instance in which it presently resides to be moved to a new software instance; thus, MD VNF may move by itself independently of any other MD VNF.

Software instances managed by an instance management program may also be configured to have access to different amounts of computational resources. Software instances that have access to greater amounts of computational resources can be used, by embodiments, to host more demanding active MD VNFs, while software instances having access to lesser amounts of computational resources can be used, by embodiments, to host active MD VNFs requiring lesser amounts of resources.

### Increased Scale, Throughput and Savings in Computational Resources

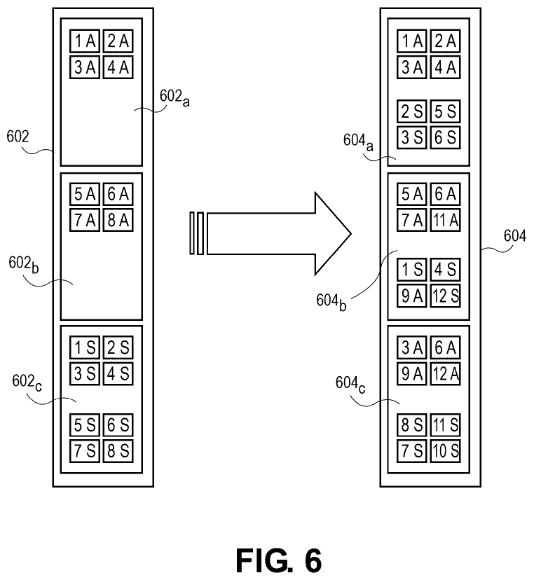

FIG. 6 is an illustration of the increased scale capacity which may be realized using an embodiment of the invention. The left side of FIG. 6 depicts a group of software instances 602_{a-c} arranged such that one software instance comprises no active MD VNFs as typical of the prior art, e.g., MD VNFs 1S-8S reside in a software instance 602, having no active MD VNFs. The right side of FIG. 6 depicts a group of software instances 604 arranged in accordance to an embodiment of the invention such that all software instance comprises at least one active VNF. The software instances 604_{a-c} of an embodiment each comprise, in their steady state, 4 active VNFs and four standby VNFs, for a total of eight MD VNFs. Note that if one of software instance fails 604_{a-c}, then all active MDs would subsequently run in the two remaining software instances. When that failed software instance would be restarted, it would run initially only standby VNFs, until the performance of failover operations to re-balance active VNFs across the operational software instances.

Each of software instances in a group is allocated the same amount of computational resources, such as access to a CPU, memory, and the like. Thus, software instances 602_{a-c} allocated the same amount of computational resources; similarly, software instances 604_{a-c} allocated the same amount of computational resources.

In the group of software instances 602_{a-c} shown on the left side of FIG. 6, in the initial state assuming no software instance in the group 602_{a-c} has failed, only those computational resources dedicated to software instance 602ₐ and 602_{b} are being used by active MD VNFs. In the case that there is a failure of either software instance 602ₐ and 602_{b}, software instance 602_{c} would become active to support those MD VNFs in the failed software instance, but at no time would there be enough active software instances in the approach followed by software instances 602_{a-c} to support more than eight separate MAC domains. The computational resources dedicate to group of software instances 602 can only support 8 different MAC domains in this concrete example, regardless of which particular software instances in the group of software instances 602 are active at any particular time. In other examples, different number of MAC domain may be supported by the group of software instances 602, but regardless of the particular number, the group of software instances 604 may support more MAC domains than software instances 602 without increasing the amount of computational resources dedicated to any particular software instance.

Assume that group of software instances 604 have available the same amount of computational resources as group of software instances 602, and thus, each of software instance 604_{a-c} is dedicated the same amount of computational resources as each of software instance. Embodiments provide increased scale capacity over the prior art be supporting 12 different MAC domains as shown on the right side of FIG. 6 by the present of MD VNF 1-12A in group of software instances 604. FIG. 6 depicts a 50% scale increase for group of software instances 604 of an embodiment over group of software instances 602 of the prior art.

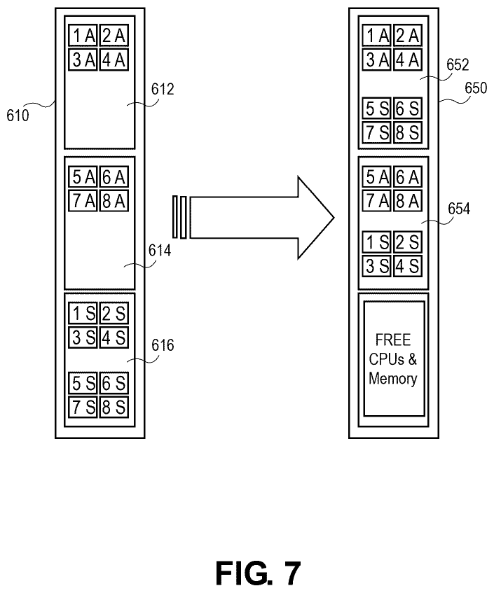

FIG. 7 is an illustration of the savings in computational resources which may be realized by managing MD VNFs in a highly available (HA) environment in accordance with an embodiment of the invention. The left side of FIG. 7 depicts a group of software instances 610 having a software instance comprising no active VNFs as typical of the prior art. The group of software instances 610 includes software instances 612, 614, and 616. Software instance 612 comprises four active MD VNFs labeled 1-4, which the appended letter ‘A’ signifying that they are active instances. Similarly, software instance 614 comprises four active MD VNFs labeled 5-8, which the appended letter ‘A’ signifying that they are active instances. As group of software instances 610 is arranged in a redundancy group, software instance 616 comprises standby MD VNF, labeled 1-8S, for each of the standby MD VNFs.

Each of software instances 612, 614, and 616 is allocated the same amount of computational resources, such as access to a CPU, memory, and the like. However, note that only two of the three software instances, namely software instances 612 and 614, comprise MD VNFs that are active and executing. Thus, since all of MD VNFs in software instance 616 are in standby mode, none of the MD VNFs in software instance 616 are presently performing work even though software instance 616 is allocated the same amount of computational resources as software instances 612 and 614.

The right side of FIG. 7 depicts a set of software instances 650 in accordance with an embodiment of the invention. Just as in the case of the left side of FIG. 7, the set of software instances 650 on the right also comprise eight different MD VNFs; which are shown in the right side of FIG. 7 as being within one of two software instances 652 and 654. The MD VNFs residing in software instances 652 and 654 are identified in FIG. 7 with a number signifying their MAC domain and an appended letter ‘A’ or ‘S’ signifying whether the instance is an active instance or a standby instance respectively. For example, software instance 654 comprises an active MD VNF 5A and software instance 652 comprises a standby MD VNF 8A.

If software instances612, 614, and 616 on the left are allocated a comparable amount of resources as software instances 652 an 654 on the right of FIG. 7, one can easy see that while the approaches shown on both the left and the right of FIG. 7 supports the same number of active and standby instances, the approach on the right involving set of software instances 650 saves about roughly one software instance's worth of allocated computational resources, such as CPU and memory. As illustrated by the approach on the right of FIG. 7 involving set of software instances 650, embodiments make greater utilization of hardware resources, such as CPU access and memory, as each software instances is working on active MD VNFs rather than merely maintaining standby MD VNFs, such as the case of software instance 616. As less computational resources are required for the proper execution of set of software instances 650, a lesser amount of electricity is required to power the hardware to provide those computational resources, which saves power and, by extension, financial cost to the operator of set of software instances 650.

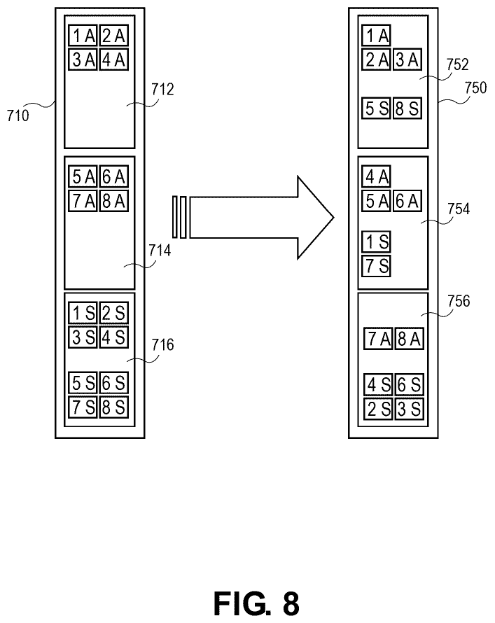

FIG. 8 is an illustration of the increased resources which may optionally be made available to active MD VNFs in a highly available (HA) environment in accordance with an embodiment of the invention. The left side of FIG. 8 depicts three software instances 710 arranged in a redundancy group. Three software instances 710 includes software instances 712, 714, and 716 which collectively support eight different active and standby MD VNFs as shown.

On the right side of FIG. 8, three software instances 750 are configured in accordance with an embodiment of the invention and without arrangement in a redundancy group. As shown in FIG. 8, three software instances 750 on the right side include software instances 752, 754, and 756. Notably, software instances 752, 754, and 756 each possess two or three active MD VNFs, whereas software instances 712 and 714 each possess four active MD VNFs. Advantageously, as demonstrated FIG. 8, assuming that software instances 750 on the right are allocated the same resources as software instances 710 on the left, without any reduction in the number of MAC domains supported, embodiments of the invention allow for a greater amount of resources to be allocated to each of the active MD VNFs in software instances 750, as a lesser number of active MD VNFs are required to execute within each software instance. Note that in every case of failure of a full software instance, the other software instances would not execute run more than 4 MD VNFs; consequently, a failure only returns to a VNF density (the number of VNFs for software instance) that was experienced in the prior art in the steady state.

Each software instance has a certain amount of bitrate which may be allocated to processes residing therein. The available bitrate of a software instance is shared across all active MD VNFs residing in that container. For example, the distribution of the available bitrate of a software instance may be spread in an equal manner to each MD VNF therein, while allowing for a certain amount of the software instance's bitrate to go unallocated to any particular MD VNF so that is available as needed when any of the MD VNFs residing in that software instance require a little more bitrate when experiencing a peak load or high traffic. The more active MD VNFs that are present in a container, the greater the amount of bitrate required to service the needs of the active MD VNFs in that software instance, which results in a smaller portion of unallocated bitrate for any particular MD VNF when needed. Advantageously, the increased amount of compute resources which may be made available to active MD VNFs by embodiments in this manner allow for an increased bitrate on average available to MD VNFs.

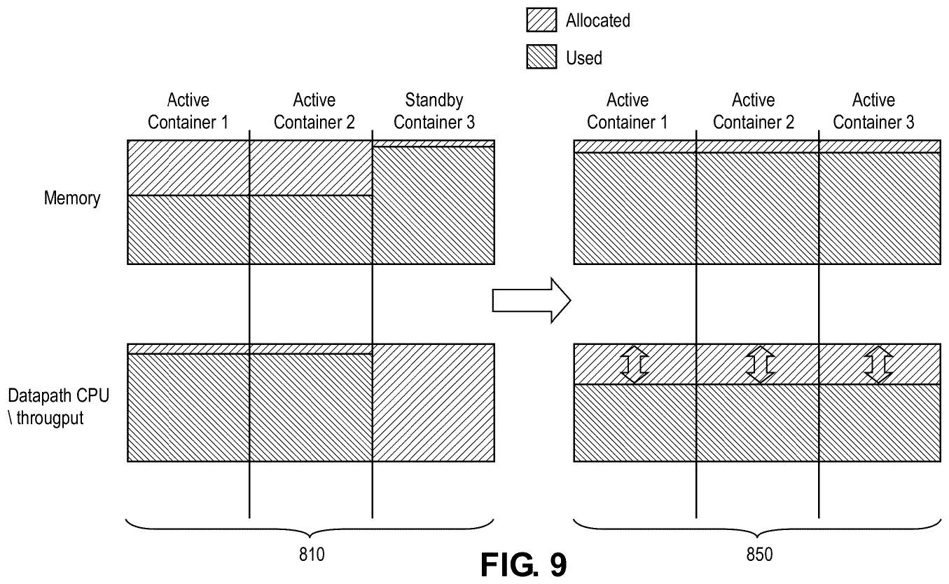

FIG. 9 is an illustration of the increased utilization of computational resources which may be realized by managing MD VNFs in a highly available (HA) environment in accordance with an embodiment of the invention. As shown in FIG. 9, conventional approaches 810 are represented on the left, while embodiments of the invention 850 are represented on the right. As can be appreciated from FIG. 9, in the steady state of operation, embodiments of the invention enjoy increased utilization of computational resources compared to conventional approaches.

Increased utilization of resources is possible by embodiments because a single software instance may host both active and standby MD VNFs, resulting in higher bandwidth because all CPU cores are processing data packets. This difference is because in the prior art model of relying upon software instance redundancy, a standby pod must be provided the same amount of resources as its corresponding active pod; as the standby pod may become active at any time, those resources must be reserved for the standby pod. Since all pods (active and standby) must be allocated with same amount of resources, some resources are wasted in the active pod (mainly memory) and some resources are wasted in the standby pod (mainly CPU and bitrate). Advantageously, embodiment of the invention may equalize the number of MAC domains all containers carry and equalize in steady state the amount of active and standby MDs, thus allowing for better allocation and utilization of resources.

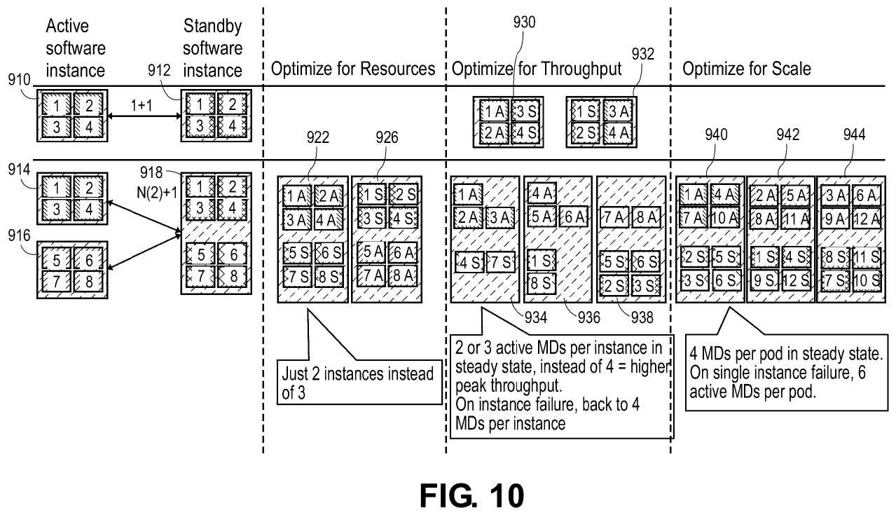

FIG. 10 is illustration of an aggregate view showing optimization techniques discussed herein for resources, throughput, and scale in accordance with certain embodiment of the invention. To understand how optimizations may be enacted, it will be helpful to review two approaches for achieving HA which are depicted in the first column on the left. In a first approach, termed 1+1, each active software instance is supported by a single standby software instance, which is shown by active software instance 910 being supported by standby software instance 912. The second approach, termed N(2)+1, involves two or more active software instances that are supported by a single standby software instance. The N(2)+1 approach is represented by active software instances 914 and 916 being supported by standby software instance 918. For a standby software instance to support an active software instance, the standby software instance must comprise at least one backup VNF for a VNF of the active software instance.

The second column of FIG. 10 revisits certain approaches discussed in relation to FIG. 7 and depicts how the N(2)+1 approach may be optimized for resources by an embodiment of the invention. Both software instances 922 and 926 comprise both active and standby MD VNFs, and so both software instances 922 and 926 are making use of their dedicated resources. Further, only two software instances (922 and 926) are required to support eight different MAC domains, as opposed to the three separate software instances shown in the N(2)+1 approach involving software instances 914, 916, and 918. Thus, the resources that would otherwise be allocated to the unneeded software instance can be preserved and used for other purposes.

The third column of FIG. 10 revisits certain approaches discussed in relation to FIG. 8 depicts how both the 1+1 approach and the N(2)+1 approach may be optimized for throughput by an embodiment of the invention. As depicted, only two to three active MD VNF per software instances are required in the steady state. For example, software instances 930, 932, and 938 each have only two active MD VNFs, while software instances 934 and 936 each have three. This is in comparison to the 4 active VNFs that are comprised in both the 1+1 approach (recall there are four active MD VNFs in software instance 910) and the N(2)+1 approach (recall there are four active MD VNFs in both software instances 914 and 916). Because the number of active MD VNFs in each software instance is reduced, active MD VNFs have a greater portion of the available resources, thereby enhancing throughput.

The fourth column of FIG. 10 revisits certain approaches discussed in relation to FIG. 6 depicts how the N(2)+1 approach may be optimized for scale by an embodiment of the invention. As shown, there are four active MD VNFs in each of software instance 940, 942, and 944. This arrangement allows for a greater number of MAC domains to be supported by MD VNFs. For example, twelve MAC domains are supported by software instances 940, 942, and 944, whereas only eight MAC domains are supported by software instances 914 and 616. Thus, using the same amount of computational resources, a fifty perfect increase in the number of MD VNFs which may be realized. When a single software instance failure occurs, the active MD VNFS in that failed software instance would be moved to one of the remaining software instances.

### Load-Balancing Mac Domain Access Instances

As each MD VNF may move by itself independently of any other MD VNF, more compute resources, such as greater bitrate\throughput, may be provided to a particular MD VNF on demand dynamically as needed. When a specific MAC domain requires more resources, other MD VNFs could be relocated to a different software instance. Alternately, when a specific MAC domain requires more resources, the active MD VNF for that MAC domain could be relocated to a new software instance having the required resources. Embodiments provide clear advantages over the current state of the art; in the prior art, if by chance MAC domains experiencing heavy traffic are assigned to be co-located in the same software instance, there may not be able to provide enough bitrate to service those MD VNFs according to their needs. In prior art, moving MDs to a different software instances (other than the current active and standby software instances) is possible, it would cause severe service interruption. With embodiments of the invention, by moving independently the standby VNF to the destination software instance and then performing failover operation, the service impact is minimal.

Some subscribers may naturally use a service more than other subscribers. However, the placement of particular MD VNFs in software instances may initially happen based on chance or without prior assessment. Thus, the particular load required of a MD VNF within any software instance generally occurs by happenstance and without prior assessment. Embodiments of the invention allow for runtime adjustments to be made to make more efficient use of hardware and computational resources.

In an embodiment, an assessment may be dynamically made in real-time that the current usage of computational resources by one or more active MD VNFs is imbalanced relative to either the available computational resources as a whole or to each other. In response, the instance management program may be instructed to dynamically perform a load balancing operation of, in whole or in part, one or more active MD VNFs entirely within runtime without ceasing the operation of any of the containers in which they inhabit.

In an embodiment, an assessment may be dynamically made in real-time that a particular MD VNF is obligated to receive a specified portion of computational resources which is greater than it is presently receiving. This may be because that particular subscribers using that MD VNF are entitled to receive a service of a particular specified quality (QoS). In response, the deployment location of that particular MD VNF may be dynamically changed from a first software instance to a second software instance entirely within runtime without ceasing the operation of either the first or second software instance. In this way, the new software instance, to which the particular MD VNF is moved, may provide that MD VNF with the specified portion of computational resources which it is entitled to receive.

Further, when demand on the system is low, such as during off-peak hours, and the present amount of hardware resources are not required to satisfy the current demand from subscribers, one or more servers may be powered down to when they are not needed. To do so, VNFs may be moved from those servers so they can be powered down, thus saving power and financial cost. To move a MD VNF in this fashion, the following steps may be performed: (1) the standby MD VNF residing at the server to be powered down is deleted, and a new standby MD VNF is created at the new location, which naturally could be a different server in a different location, (2) the MAC Domain is placed in a protected state, and then the MAC Domain performs a failover maneuver.

MD VNFs, using embodiments of the invention, may also be consolidated in this fashion in off-hours or periods of reduced demand. Further, as hardware resources become needed once again, those servers may be powered on, and as software instances become available on those servers, MD VNFs may be migrated back to those new containers using embodiments of the invention. As computational resources become available due to servers going online, embodiments of the invention allow for load-balancing to occur to ensure optimal usage of the newly available computational resources.

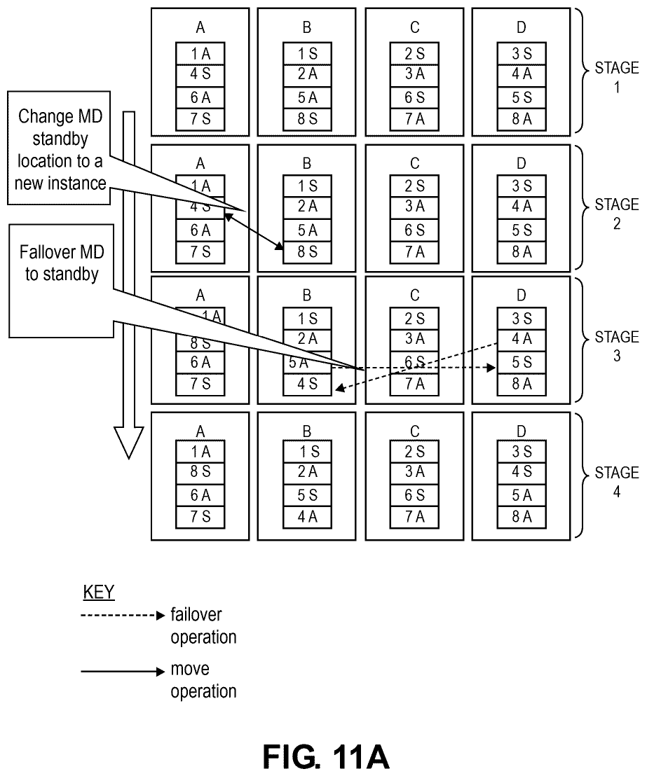

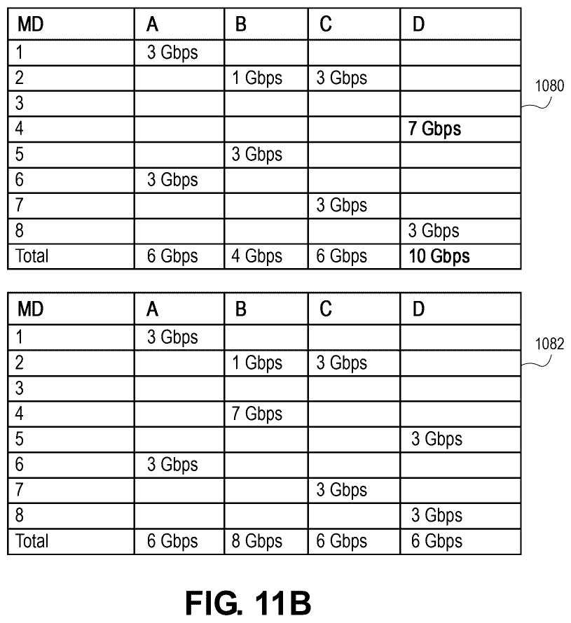

FIGS. 11A and 11B are two halves of an illustration of performing dynamic load balancing of MD VNFs using an embodiment of the invention. FIG. 11A shows four stages of four different software instances labeled A, B, C, and D. Each of the software instances labeled A-D comprise four MD VNFs, which are each labeled with a number to identify a MAC domain and either the letter A to identify the MD VNF as being designated active or the letter S to identify the MD VNF as being designated standby.

The bitrate consumed by each MD VNF in stage 1 is depicted in Table 1080 of FIG. 11B. As shown in Table 1080, the MD VNF 4A in software instance D is experiencing a heavy load and consuming a bitrate of 7 Gbps. As a result, the total bitrate consumed by software instance D is 10 Gbps, which is more than the other software instances. When a particular software instance consumes more resources than other software instances beyond some configurable threshold, a load balancing operation may be performed.

The performance of load balancing operations on software instances A-D is shown in stages 2, 3, and 4 of FIG. 11A. The purpose of a load balancing operation is to more evenly distribute the capabilities of a set of software instances to cover the present demand. After an assessment of demand is performed, the information depicted in Table 1080 would be known to the software entity performing the load balancing operation (hereafter the “load balancing manager”), which may be the instance management program, the CMTS, or a VNF orchestrator. The load balancing manager may, as shown in stages 2 and 3, perform a move operation to change the deployment location of MD VNF 4S from software instance A to software instance B and perform a move operation to change the deployment location of MD VNF 8S from software instance B to software instance A. Thereafter, the load balancing manager may also perform a failover operation on MD VNF 4A so that the MD VNF 4A in software instance D becomes the standby instance and the standby MD VNF for MAC domain 4, which was previously moved to software instance B, becomes the active instance. Further, the load balancing manager may also perform a failover operation on MD VNF 5A so that the MD VNF 5A in software instance B becomes the standby instance and the standby MD VNF for MAC domain 5 in software instance D becomes the active instance.

The result of performing these operations is shown in Table 1082 of FIG. 11B, which shows the state of software instances A-D in stage 4. As shown in Table 1082, the total bitrate consumed by software instances D is reduced from 10 Gbps to 6 Gbps, and no other software instance is consuming more than 8 Gbps. Advantageously, load-balancing VNFs in this fashion ensure optimal usage of the available computational resources; as both demand and computational resources are dynamic in nature, embodiments allow for the present set of available computational resources to be deployed in an optimal, or desired, manner to service the current set of customer demand placed upon the VNFs in the system.

### Implementing Mechanisms

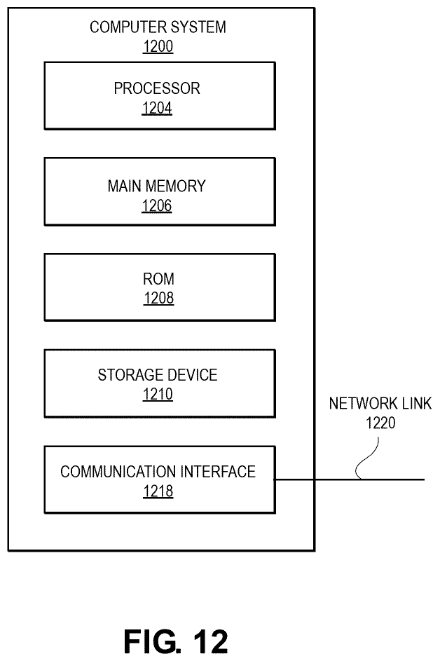

Embodiments of the invention are implemented upon a computer system., e.g, a CMTS and an OLT may each be built using one or more computer systems. The functions of a CMTS and an OLT may be build using multiple computer systems arranged in a fault-tolerant manner, such as a cluster. FIG. 12 is a block diagram of a computer system that may correspond to, in whole or in part, CMTS 220 of FIG. 2 or OLT 320 of FIG. 3 in accordance with an embodiment of the invention. In an embodiment, computer system 1200 includes processor 1204, main memory 1206, ROM 1208, storage device 1210, and communication interface 1218. Computer system 1200 includes at least one processor 1204 for processing information. Computer system 1200 also includes a main memory 1206, such as a random-access memory (RAM) or other dynamic storage device, for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device for storing static information and instructions for processor 1204. A storage device 1210, such as a magnetic disk or optical disk, is provided for storing information and instructions.

Embodiments of the invention are related to the use of computer system 1200 for implementing the techniques described herein. According to one embodiment of the invention, those techniques are performed by computer system 1200 in response to processor 1204 executing one or more sequences of one or more instructions contained in main memory 1206. Such instructions may be read into main memory 1206 from another machine-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “non-transitory computer-readable storage medium” as used herein refers to any tangible medium that participates in storing instructions which may be provided to processor 1204 for execution. Non-limiting, illustrative examples of non-transitory machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of non-transitory computer-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a network link 1220 to computer system 1200.

Communication interface 1218 provides a two-way data communication coupling to a network link 1220 that is connected to a local network. For example, communication interface 1218 may be an integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through a local network to a host computer or to data equipment operated by an Internet Service Provider (ISP).

Computer system 1200 can send messages and receive data, including program code, through the network(s), network link 1220 and communication interface 1218. For example, a server might transmit a requested code for an application program through the Internet, a local ISP, a local network, subsequently to communication interface 1218. The received code may be executed by processor 1204 as it is received, and/or stored in storage device 1210, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A non-transitory computer-readable storage medium storing one or more sequences of instructions for dynamic, seamless management of a virtual network function (VNF) in a highly available (HA) environment, which when executed by one or more processors, cause:
upon determining that a failover operation should be performed upon a particular active MAC domain (MD) VNF, residing within a first software instance managed by an instance management program, causing a standby MD VNF for said particular active MD VNF, residing in a second software instance managed by said instance management program, to become active during runtime without ceasing operation of any of: (a) said first software instance, (b) said second software instance, and (c) any other MD VNFs besides said particular active MD VNF and said standby MD VNF also executing in either of said first software instance or said second software instance.

2. A non-transitory computer-readable storage medium storing one or more sequences of instructions for dynamic, seamless management of a virtual network function (VNF) in a highly available (HA) environment, which when executed by one or more processors, cause:
upon determining that a particular VNF, of a plurality of VNFs that each execute within a first software instance managed by an instance management program, should be moved to a second software instance, moving the particular VNF from the first software instance to the second software instance without ceasing operation of any other of said plurality of VNFs also executing in said first software instance.

3. The non-transitory computer-readable storage medium of claim 2, wherein said instance management program determines that said particular VNF should be moved from said first software instance to said second software instance.

4. The non-transitory computer-readable storage medium of claim 2, wherein a different entity than said instance management program determines that said particular VNF should be moved from said first software instance to said second software instance.

5. The non-transitory computer-readable storage medium of claim 2, wherein the plurality of VNFs are each MAC Domain (MD) VNFs which implement a Data Over Cable Service Interface Specifications (DOCSIS) Cable Modem Termination System (CMTS) MAC layer for a particular MAC Domain.

6. The non-transitory computer-readable storage medium of claim 2, wherein at least one of said first software instance and said second software instance comprises at least one active VNF and at least one standby VNF.

7. The non-transitory computer-readable storage medium of claim 2, wherein said instance management program operates as part of, or with, a Cable Modem Termination System (CMTS), and wherein each of said plurality of VNFs is a logical unit for performing DOCSIS functions for a set of channels extending at least between the CMTS and a plurality of Cable Modems (CMs).

8. The non-transitory computer-readable storage medium of claim 2, wherein said instance management program operates as part of, or with, a Passive Optical Network (PON), and wherein each of said plurality of VNFs performs functions pertaining to a PON port.

9. The non-transitory computer-readable storage medium of claim 2, wherein said instance management program operates as part of, or with, a Broadband Network Gateway (BNG).

10. The non-transitory computer-readable storage medium of claim 2, wherein execution of the one or more sequences of instructions by the one or more processors further cause:
in response to dynamically assessing that a proportion of use of available computational resources, available to said first software instance, by said plurality of VNFs that execute within said first software instance is imbalanced relative to an amount of said computational resources available to said first software instance, dynamically performing a move operation on one or more VNFs executing across a plurality of software instances managed by said instance management program entirely within runtime without ceasing the operation of any of said plurality of software instances.

11. The non-transitory computer-readable storage medium of claim 2, wherein execution of the one or more sequences of instructions by the one or more processors further cause:
in response to determining that a policy instructs that a deployment location of one or more VNFs, executing across a plurality of software instances managed by said instance management program, should be adjusted, dynamically performing a move operation on said one or more VNFs entirely within runtime without ceasing the operation of any of said plurality of software instances.

12. The non-transitory computer-readable storage medium of claim 2, wherein said instance management program determines that said particular VNF should be moved from said first software instance to said second software instance in response to dynamically assessing that said particular VNF is obligated to receive a specified portion of computational resources which is greater than said particular VNF is presently receiving at said first software instance.

13. An apparatus for dynamic, seamless management of a virtual network function (VNF) in a highly available (HA) environment, comprising:
one or more processors; and
one or more non-transitory computer-readable storage mediums storing one or more sequences of instructions, which when executed, cause:
upon determining that a failover operation should be performed upon a particular active MAC domain (MD) VNF, residing within a first software instance managed by an instance management program, causing a standby MD VNF for said particular active MD VNF, residing in a second software instance managed by said instance management program, to become active during runtime without ceasing operation of any of: (a) said first software instance, (b) said second software instance, and (c) any other MD VNFs besides said particular active MD VNF and said standby MD VNF also executing in either of said first software instance or said second software instance.

14. An apparatus for dynamic, seamless management of a virtual network function (VNF) in a highly available (HA) environment, comprising:
one or more processors; and
one or more non-transitory computer-readable storage mediums storing one or more sequences of instructions, which when executed, cause:
upon determining that a particular VNF, of a plurality of VNFs that each execute within a first software instance managed by an instance management program, should be moved to a second software instance, moving the particular VNF from the first software instance to the second software instance without ceasing operation of any other of said plurality of VNFs also executing in said first software instance.

15. The apparatus of claim 14, wherein said instance management program determines that said particular VNF should be moved from said first software instance to said second software instance.

16. The apparatus of claim 14, wherein a different entity than said instance management program determines that said particular VNF should be moved from said first software instance to said second software instance.

17. The apparatus of claim 14, wherein the plurality of VNFs are each MAC Domain (MD) VNFs which implement a Data Over Cable Service Interface Specifications (DOCSIS) Cable Modem Termination System (CMTS) MAC layer for a particular MAC Domain.

18. The apparatus of claim 14, wherein at least one of said first software instance and said second software instance comprises at least one active VNF and at least one standby VNF.

19. The apparatus of claim 14, wherein said instance management program operates as part of, or with, a Cable Modem Termination System (CMTS), and wherein each of said plurality of VNFs is a logical unit for performing DOCSIS functions for a set of channels extending at least between the CMTS and a plurality of Cable Modems (CMs).

20. The apparatus of claim 14, wherein said instance management program operates as part of, or with, a Passive Optical Network (PON), and wherein each of said plurality of VNFs performs functions pertaining to a PON port.

21. The apparatus of claim 14, wherein said instance management program operates as part of, or with, a Broadband Network Gateway (BNG).

22. The apparatus of claim 14, wherein execution of the one or more sequences of instructions by the one or more processors further cause:
in response to dynamically assessing that a proportion of use of available computational resources, available to said first software instance, by said plurality of VNFs that execute within said first software instance is imbalanced relative to an amount of said computational resources available to said first software instance, dynamically performing a move operation on one or more VNFs executing across a plurality of software instances managed by said instance management program entirely within runtime without ceasing the operation of any of said plurality of software instances.

23. The apparatus of claim 14, wherein execution of the one or more sequences of instructions by the one or more processors further cause:
in response to determining that a policy instructs that a deployment location of one or more VNFs, executing across a plurality of software instances managed by said instance management program, should be adjusted, dynamically performing a move operation on said one or more VNFs entirely within runtime without ceasing the operation of any of said plurality of software instances.

24. The apparatus of claim 14, wherein said instance management program determines that said particular VNF should be moved from said first software instance to said second software instance in response to dynamically assessing that said particular VNF is obligated to receive a specified portion of computational resources which is greater than said particular VNF is presently receiving at said first software instance.
